(19) United States
(12) Patent Application Publication
(10) Pub. No.: US 2026/0203088 A1
(43) Pub. Date: Jul. 16, 2026

(54) Orchestration to Update an External Subnet of a Clustered Filesystem on a Cloud Platform

(71) Applicant: Dell Products L.P., Round Rock, TX (US)

(72) Inventors: Steven Soumpholphakdy, Austin, TX (US); Melody Grappo, Everett, WA (US); Alexander Bahm, Renton, WA (US)

(21) Appl. No.: 19/019,402

(22) Filed: Jan. 13, 2025

(51) Int. Cl. G06F 9/455

(52) U.S. Cl. CPC G06F 9/45558; G06F 2009/45595

(57) ABSTRACT

A system can, for a cluster that comprises a group of nodes and that hosts a group of virtual machines, create and attach respective new virtual network interface cards to respective virtual machines of the group of virtual machines, wherein the respective new virtual network interface cards are assigned to the new external subnet. The system can create the new external subnet. The system can delete respective current virtual network interface cards from the respective virtual machines, wherein the respective current virtual network interface cards are assigned to the current external subnet. The system can acquire respective dynamic host control protocol leases for the respective virtual machines, wherein the respective dynamic host control protocol leases correspond to the new external subnet. The system can halt a connection from a computer on the new external subnet via the respective new virtual network interface cards.

### BACKGROUND

A computer cluster can comprise multiple computer nodes that are configured to operate as one logical computer.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can, based on determining to update an external subnet from a current external subnet to a new external subnet, for a cluster that comprises a group of nodes and that hosts a group of virtual machines, create and attach respective new virtual network interface cards to respective virtual machines of the group of virtual machines, wherein the respective new virtual network interface cards are assigned to the new external subnet. The system can set the cluster to a maintenance mode. The system can create the new external subnet. The system can delete respective current virtual network interface cards from the respective virtual machines, wherein the respective current virtual network interface cards are assigned to the current external subnet. The system can acquire respective dynamic host control protocol leases for the respective virtual machines, wherein the respective dynamic host control protocol leases correspond to the new external subnet. The system can halt the maintenance mode for the cluster. The system can halt a connection from a computer on the new external subnet via the respective new virtual network interface cards.

An example method can comprise creating and attaching, by a system comprising at least one processor, respective first virtual network interface cards to respective virtual machines, wherein the respective first virtual network interface cards are assigned to a new external subnet. The method can further comprise setting, by the system, a cluster that comprises the virtual machines to a maintenance mode. The method can further comprise creating, by the system, the new external subnet. The method can further comprise deleting, by the system, respective second virtual network interface cards from the respective virtual machines, wherein the respective second virtual network interface cards are assigned to a current external subnet. The method can further comprise acquiring, by the system, respective dynamic host control protocol leases for the respective virtual machines, wherein the respective dynamic host control protocol leases correspond to the new external subnet. The method can further comprise halting, by the system, the maintenance mode for the cluster. The method can further comprise accessing, by the system, the new external subnet by the cluster via the respective first virtual network interface cards.

An example non-transitory computer-readable medium can comprise instructions that, in response to execution, cause a system comprising a processor to perform operations. These operations can comprise creating and attaching respective first virtual network interface cards to respective virtual machines, wherein the respective first virtual network interface cards are assigned to a first external subnet. These operations can further comprise setting a cluster that comprises the virtual machines to a maintenance mode. These operations can further comprise creating the first external subnet. These operations can further comprise deleting respective second virtual network interface cards from the respective virtual machines, wherein the respective second virtual network interface cards are assigned to a second external subnet. These operations can further comprise reacquiring respective dynamic host control protocol leases for the respective virtual machines, wherein the respective dynamic host control protocol leases correspond to the second external subnet. These operations can further comprise halting the maintenance mode for the cluster. These operations can further comprise accessing the second external subnet by the cluster via the respective first virtual network interface cards.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate orchestration to update an external subnet of a clustered filesystem on a cloud platform, in accordance with an embodiment of this disclosure;

FIG. 2 illustrates an example signal flow that can facilitate orchestration to update an external subnet of a clustered filesystem on a cloud platform, in accordance with an embodiment of this disclosure;

FIG. 3 illustrates another example signal flow that can facilitate orchestration to update an external subnet of a clustered filesystem on a cloud platform, in accordance with an embodiment of this disclosure;

FIG. 4 illustrates an example process flow that can facilitate orchestration to update an external subnet of a clustered filesystem on a cloud platform, in accordance with an embodiment of this disclosure;

FIG. 5 illustrates an example process flow that can facilitate orchestration to update an external subnet of a clustered filesystem on a cloud platform, in accordance with an embodiment of this disclosure;

FIG. 6 illustrates an example process flow that can facilitate orchestration to update an external subnet of a clustered filesystem on a cloud platform, in accordance with an embodiment of this disclosure;

FIG. 7 illustrates an example process flow that can facilitate orchestration to update an external subnet of a clustered filesystem on a cloud platform, in accordance with an embodiment of this disclosure;

FIG. 8 illustrates another example process flow that can facilitate orchestration to update an external subnet of a clustered filesystem on a cloud platform, in accordance with an embodiment of this disclosure;

FIG. 9 illustrates another example process flow that can facilitate orchestration to update an external subnet of a clustered filesystem on a cloud platform, in accordance with an embodiment of this disclosure;

FIG. 10 illustrates an example block diagram of a computer operable to execute an embodiment of this disclosure.

### DETAILED DESCRIPTION

### Overview

Disruptive operations occur as part of a client network switch, such as from accepting connections from one external subnet (a logical subdivision of an (IP) network) to another. Where a client network switch is performed manually, there can be a problem associated with multiple, relatively long disruptions. The present techniques can be implemented to reduce the number and duration of disruptions in a client network switch, relative to manual approaches.

In an as-a-Service Cloud deployment, end users can choose to update their client-side delegated subnet. A use case to do this can be where an organization decides to move their clients to a new virtual network (vNET; a logically isolated network within a cloud environment) and subsequently a new subnet. This can be similar to a lab re-IP (a changing of Internet Protocol (IP) addresses associated with various devices) or move of lab infrastructure (resulting in a re-IP) in an on-premises hardware scenario.

The present techniques can be implemented to provide a solution to problems with these operations that can reduce a number of steps that the end user performs, and minimize a connectivity impact on the end user.

There can be other approaches that involve more intervention by an end user compared to the present techniques. For example, a new desired subnet can be added and cluster network interfaces can be moved, which could cause a client disconnect (due to re-IP). Next, the end user could transition their clients to the new subnet. Then a step could involve acknowledgement that this has been completed such that the old subnet can be deleted.

A cloud platform can provide capabilities that can be used for automation of the present techniques.

Consider an example where an end user updates an external subnet of a computer cluster that is deployed in the cloud. The end user has access to configure and use a cluster-aware domain name system load balancing server.

In this example, the end user has created a new subnet as part of an example workflow, and details of this new subnet are available.

In this example, to perform a network cutover, a beginning step comprises creating new virtual NICs. These virtual NICs can be added to the new subnet later on in the workflow.

Ahead of starting the cutover process, a node can be set into maintenance mode. For this workflow, maintenance mode can start a drain service on all nodes in the cluster, where a drain service can prevent new connections on the nodes.

During the cutover, there can be two client disconnections that occur (e.g., re-IP and interface shuffle (moving an IP address from one network interface to another), so setting maintenance mode, and subsequently starting the drain service, can avoid new connections to be made during that time and minimize the timeframe between the two cutovers to expedite the process.

Once in maintenance mode, a configuration can be cloned from the old to the new subnet. There can be specific fields to carry over such as: service name, descriptions, names, domain name system (DNS) zone, DNS zone aliases, time-to-live (TTL), allocation/connect policy, configure interfaces, and provisioning rules.

Once the configuration has been cloned, cluster-aware domain name system load balancing server IP addresses can be set to IP addresses within the new subnet range.

Next, the subnet and pool can be deleted from an operating system of the cluster. From point of view of the cloud, the NICs that were associated with the old subnet can then be torn down.

At this point, there can be a commit to perform the network cutover. As part of the commit, each node can watch for device changes due to the NIC having been torn down in the cloud. Once the old devices have been removed, a re-probe of the network devices can be triggered, and a result can be reflected in a logical network interface configuration file (e.g., lni.xml). LNI.xml can contain information used by a daemon (which can generally comprise a background computer process, that in some examples, runs without user interaction), where the information can provide details about each NIC and their intended usage. The daemon can be configured to handle enforcement of the network configuration for all nodes on the cluster (e.g., per device Internet Protocol (IP) address(es), IP gateway, netmask, etc.).

This daemon can generally be part of a cluster network management system. Network interface cards (NICs) can be known to a computer's operating system (OS), and have names (e.g., vmx0), but it can be that these names are unique only locally, and do not indicate an interface's usage.

NICs are a concept known to the OS, which can have locally unique names such as vmx0 but that do not indicate how the interface is used within the cluster as a whole. Further, with on-prem deployments, different vendors making the same speed of interface can use different names (e.g., one vendor can use the name mlxen0, while another vendor uses the name bxe0). When managing large numbers of interfaces, this can make it challenging to identify which interfaces to select for a given management operation.

A logical network interface (LNI) can comprise an abstraction layer to generalize names of interfaces (e.g., to <interface type><index>). For a cloud implementation, a name can be of the form ext-1 (for external), for on-prem, a name can be of the form 100gige-1 (to indicate that the interface offers 100 gigabit Ethernet connectivity). A LNI name (and associated attributes) can have a 1:1 reference with a NIC-e.g., ext-1 can map to vmx2.

There can be a layer on top of LNI, that absorbs some of lni.xml, where the layer identifies not just an interface on a node, but within a cluster. That can result in an example of, 1:ext-1 (or ext-1 on node 1). As part of that, the daemon can possess a copy of a portion of lni.xml kept in shared storage. This can be used so that, if an end user tries to make a configuration change, attributes of the interface can be verified to make sure it is valid. For example, there can be an option that requires that all interfaces added to a given network pool must support remote direct memory access (RDMA). When an end user tries to add an interface to one of these pools, the attributes of the LNI can be checked to ensure that it supports RDMA before adding it to the pool.

In combination with that, the daemon can take this information (e.g., network configuration, how to allocate IP addresses, etc.), and use that to ensure the network on each node is configured correctly. It can ensure that the correct IP addresses are configured on the correct interfaces, and have the correct routes/gateways configured.

The information in LNI. xml that can provide details about each NIC and their intended usage, and that can used by the daemon can include details, such as device name, logical name (e.g., ext-1, ext-2, int-a, etc . . . ), Medium Access Control (MAC) address, intended usage (e.g., external, internal), network interface card (NIC) type, and other relevant attributes. Updating lni. xml after the old device has been removed can effectively do a rename of the new NICs from ext-2 (when they were created) to ext-1 (now that the old NICs have been removed). Once this is complete, a Dynamic Host Control Protocol (DHCP) lease can be re-acquired. This part can be performed automatically based on the old NIC having been removed/deleted.

Now that the cutover has been performed, maintenance mode can be unset, which can stop a drain service from all nodes in the cluster.

Now that the network cutover has been completed, the end user can update DNS delegation records to point to the new a cluster-aware domain name system load balancing server Internet Protocol (IP) addresses.

The present techniques can be implemented to facilitate orchestration to update an external subnet of a computer cluster.

The present techniques can be implemented to create a workflow that aims to minimize impact on the end user while ensuring that the outcome of having an updated subnet is met. This workflow can include cloud provider application programming interfaces (APIs) (e.g., create/teardown a NIC) along with an API to coordinate the network cutover.

The present techniques can be implemented to automate cutover of a primary IP pool from an old to new subnet. This can be captured within pre-commit and commit stages. In the pre-commit stage, the configuration can be cloned from the old subnet to the new subnet. In the commit step, devices being torn down can be monitored, and use internal platform support infrastructure (PSI) processes to re-probe devices and update the lni. xml, and lastly reacquire a DHCP lease.

Prior approaches in this area were directed to on-premises hardware deployments. These approaches are generally manual and are not feasible to have an end user execute. Orchestrating such a workflow can provide a less user friendly experience than the present techniques.

### Example Architecture, Signal Flows

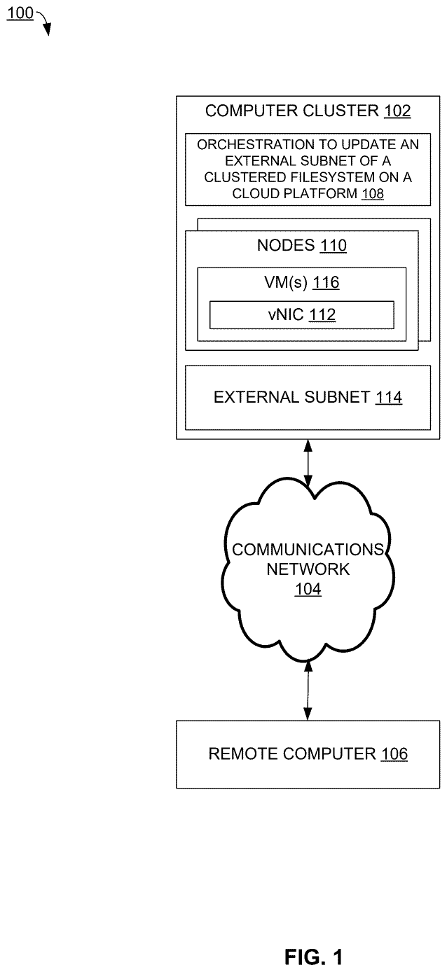

FIG. 1 illustrates an example system architecture 100 that can facilitate orchestration to update an external subnet of a clustered filesystem on a cloud platform, in accordance with an embodiment of this disclosure.

System architecture 100 comprises computer cluster 102, communications network 104, and remote computer 106. Computer cluster 102 comprises orchestration to update an external subnet of a clustered filesystem on a cloud platform component 108, nodes 110 (which can each comprise one or more VMs of VM(s) 116, which in turn each comprise one or more instances of virtual NIC (vNIC) 112), and external subnet 114.

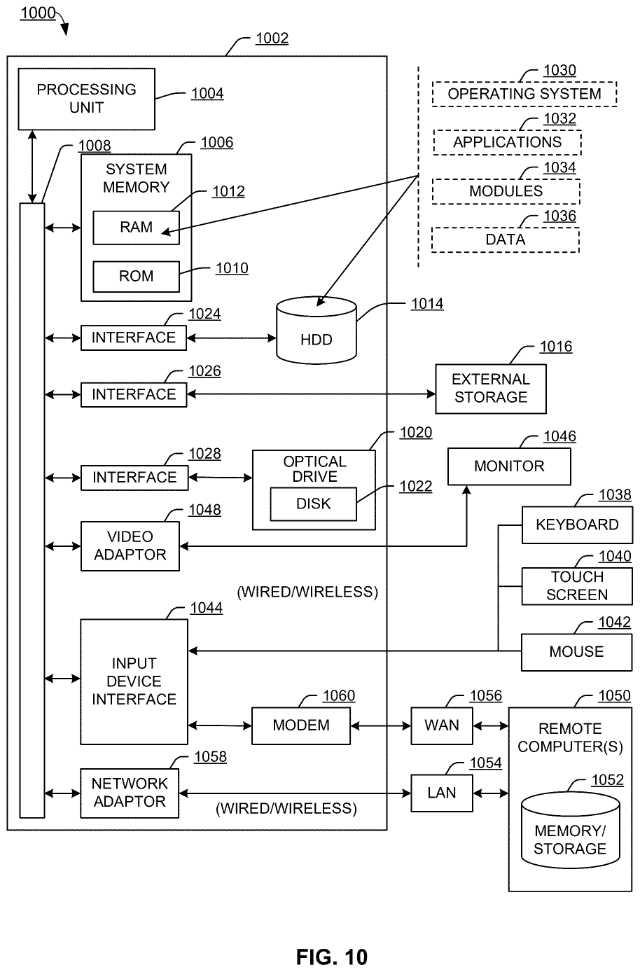

Each of computer cluster 102 and/or remote computer 106 can be implemented with part(s) of computing environment 1000 of FIG. 10. Communications network 104 can comprise a computer communications network, such as the Internet.

Remote computer 106 can access computer cluster 102 via communications network 104 to prompt modifying external subnet 114 (e.g., to change which IP addresses are associated with external subnet 114). Orchestration to update an external subnet of a clustered filesystem on a cloud platform component 108 can then modify external subnet 114, create new vNICs that are configured for the modified external subnet and associate them with each node of nodes 110, and delete the prior vNICs.

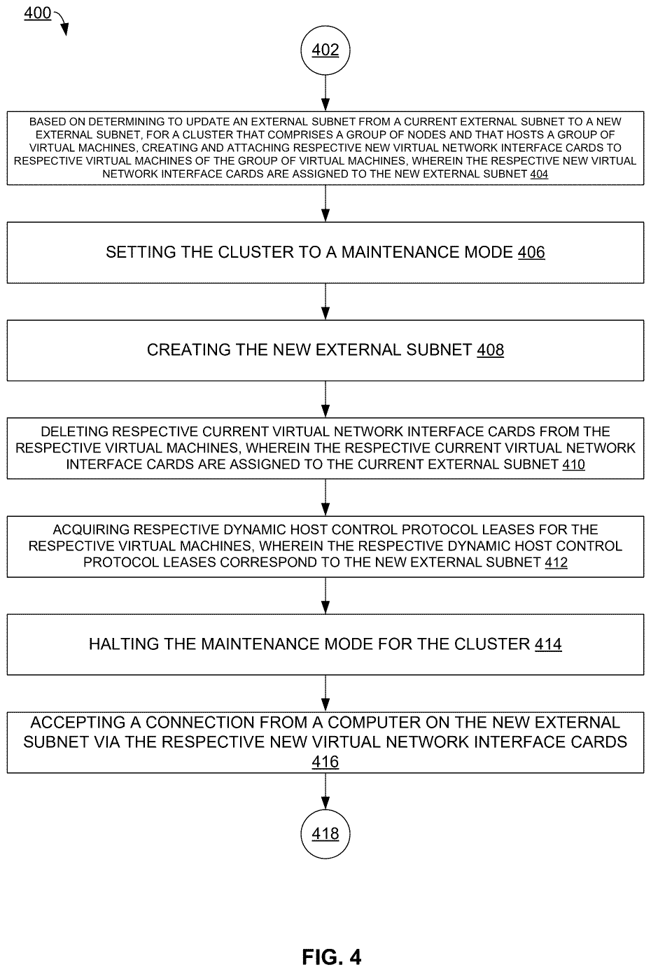

In some examples, orchestration to update an external subnet of a clustered filesystem on a cloud platform component 108 can implement part(s) of the process flows of FIGS. 4-9 to implement orchestration to update an external subnet of a clustered filesystem on a cloud platform.

It can be appreciated that system architecture 100 is one example system architecture for orchestration to update an external subnet of a clustered filesystem on a cloud platform, and that there can be other system architectures that facilitate orchestration to update an external subnet of a clustered filesystem on a cloud platform.

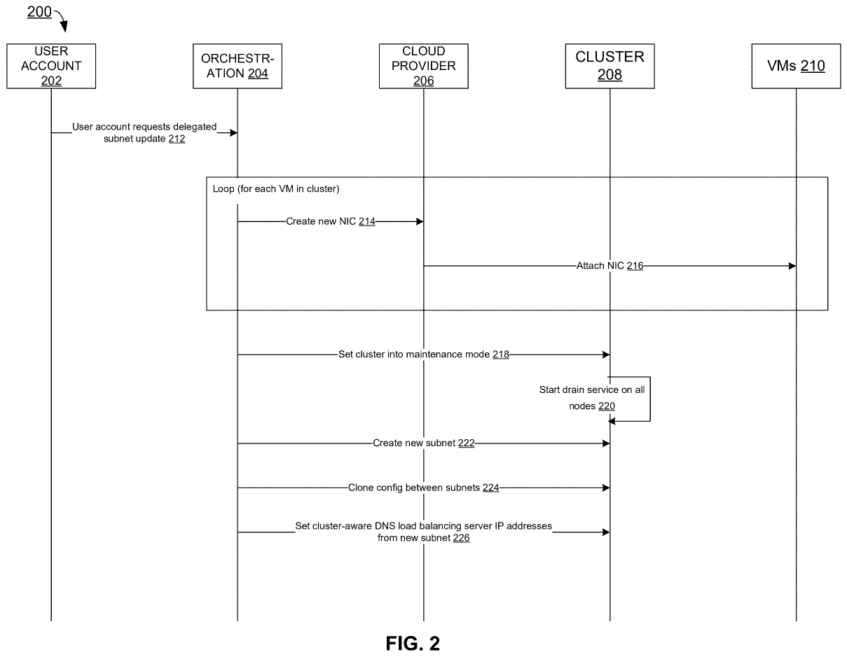

FIG. 2 illustrates an example signal flow 200 that can facilitate orchestration to update an external subnet of a clustered filesystem on a cloud platform, in accordance with an embodiment of this disclosure. In some examples, part(s) of signal flow 200 can be implemented by part(s) of system architecture 100 of FIG. 1 to facilitate orchestration to update an external subnet of a clustered filesystem on a cloud platform.

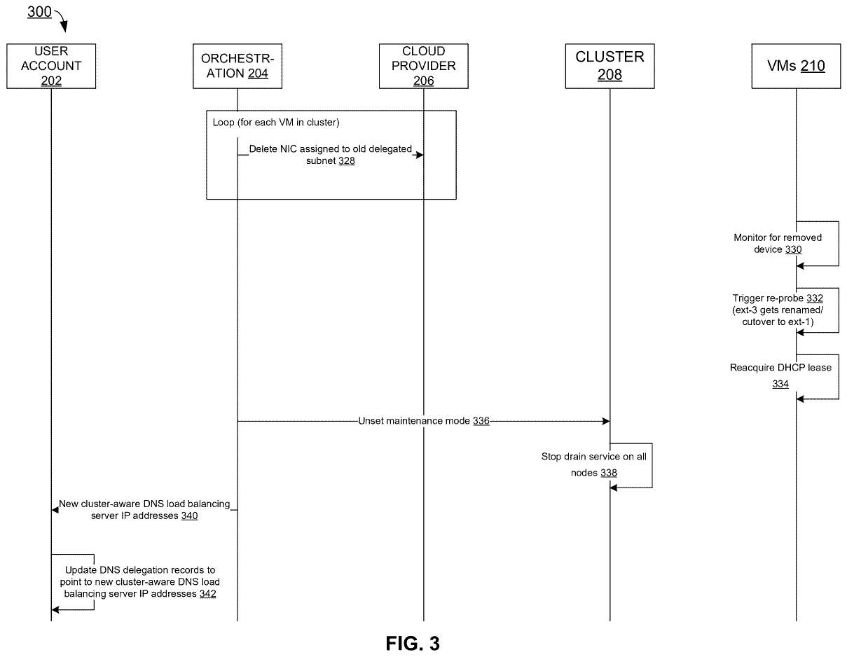

Signal flow 200 can be implemented in conjunction with signal flow 300 of FIG. 3, with signal flow 200 performed first.

Signals of signal flow 200 (and signal flow 300 of FIG. 3) occur between user account 202, orchestration 204, cloud provider 206, cluster 208, and VMs 210. Signals of signal flow 200 are:
User account requests delegated subnet update 212;
Create new NIC 214;
Attach NIC 216;
Set cluster into maintenance mode 218;
Start drain service on all nodes 220;
Create new subnet 222;
Clone config between subnets 224; and
Set cluster-aware domain name system load balancing server IPs from new subnet 226.

FIG. 3 illustrates another example signal flow 300 that can facilitate orchestration to update an external subnet of a clustered filesystem on a cloud platform, in accordance with an embodiment of this disclosure. In some examples, part(s) of signal flow 300 can be implemented by part(s) of system architecture 100 of FIG. 1 to facilitate orchestration to update an external subnet of a clustered filesystem on a cloud platform.

Signal flow 300 can be implemented in conjunction with signal flow 200 of FIG. 2, with signal flow 200 performed first.

Signals of signal flow 300 (and signal flow 200 of FIG. 2) occur between user account 202, orchestration 204, cloud provider 206, cluster 208, and VMs 210. Signals of signal flow 300 are:
Delete NIC assigned to old delegated subnet 328;
Monitor for removed device 330;
Trigger re-probe 332 (ext-2 gets renamed/cutover to ext-1);
Reacquire DHCP lease 334;
Unset maintenance mode 336;
Stop drain services on nodes 338;
New cluster-aware domain name system load balancing server IP addresses 340; and
Update DNS delegation records to point to new cluster-aware domain name system load balancing server IPs 342.

### Example Process Flows

FIG. 4 illustrates an example process flow 400 that can facilitate orchestration to update an external subnet of a clustered filesystem on a cloud platform, in accordance with an embodiment of this disclosure. In some examples, one or more embodiments of process flow 400 can be implemented by orchestration to update an external subnet of a clustered filesystem on a cloud platform component 108 of FIG. 1, or computing environment 1000 of FIG. 10.

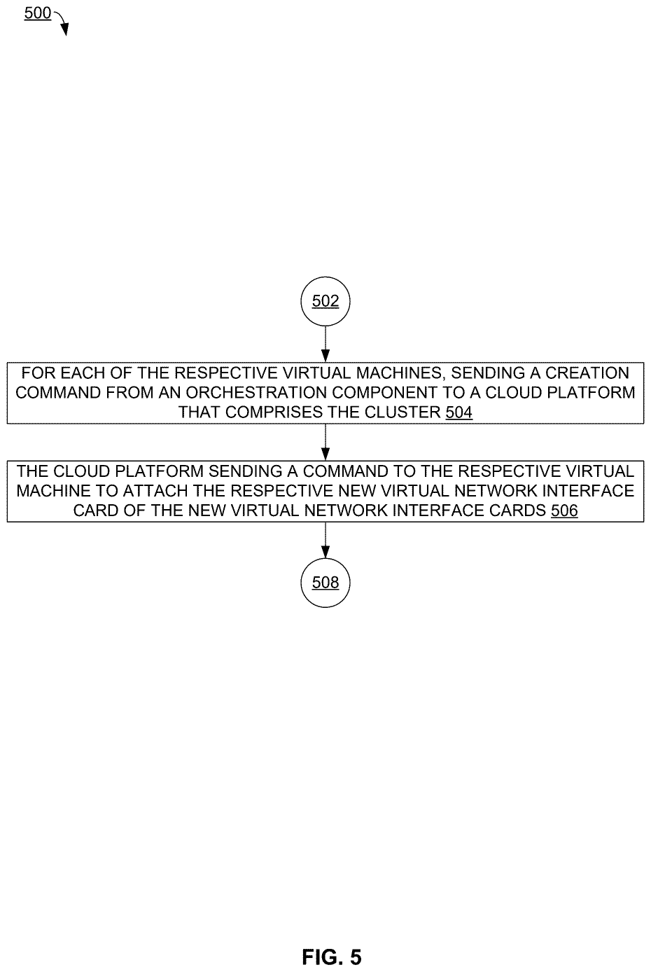

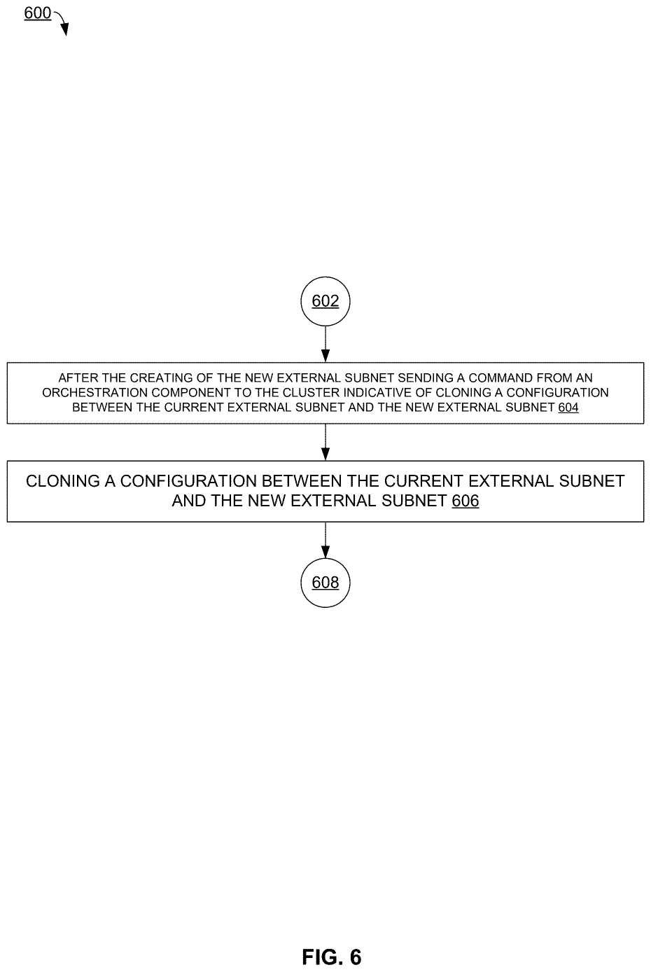

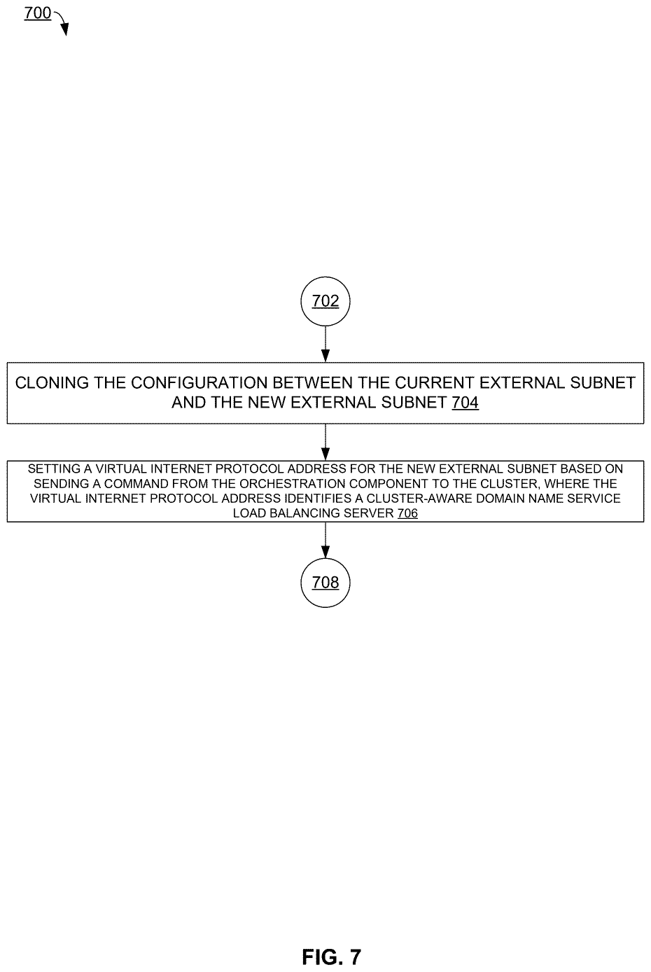

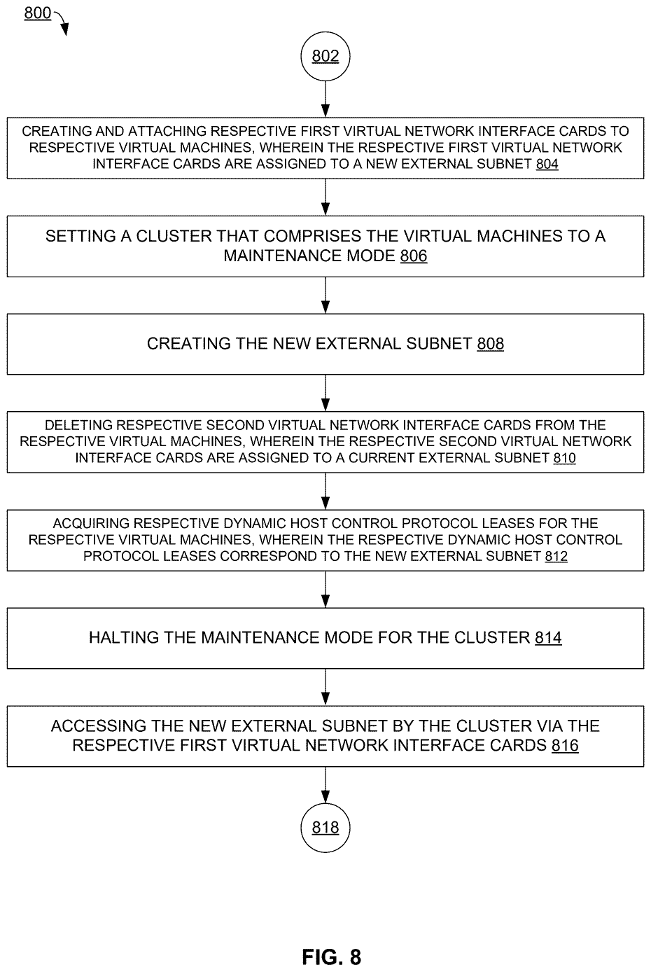

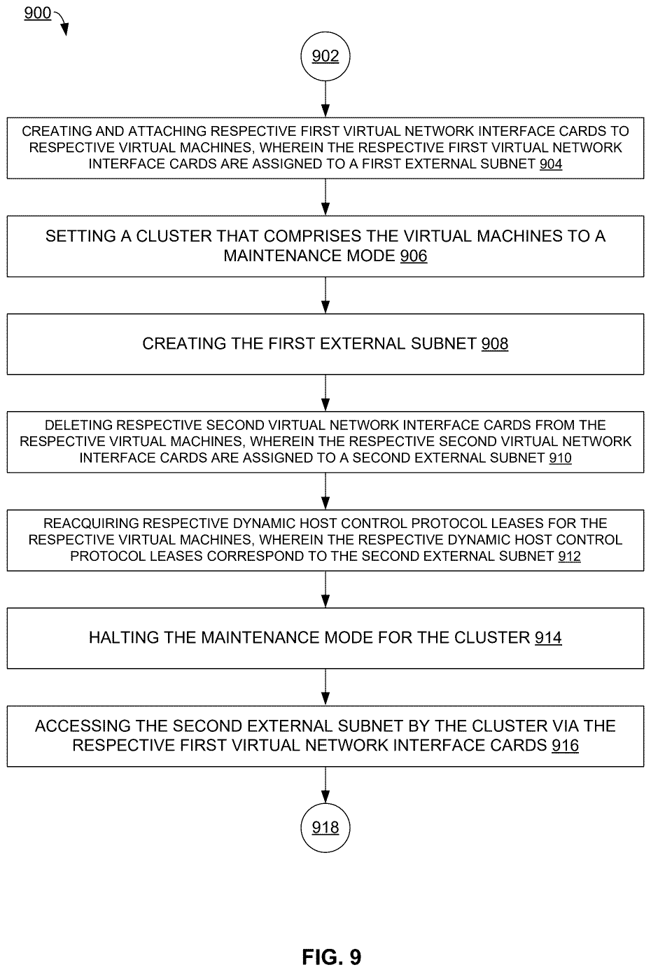

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 500 of FIG. 5, process flow 600 of FIG. 6, process flow 700 of FIG. 7, process flow 800 of FIG. 8, and/or process flow 900 of FIG. 9.

Process flow 400 begins with 402, and moves to operation 404.

Operation 404 depicts, based on determining to update an external subnet from a current external subnet to a new external subnet, for a cluster that comprises a group of nodes and that hosts a group of virtual machines, creating and attaching respective new virtual network interface cards to respective virtual machines of the group of virtual machines, wherein the respective new virtual network interface cards are assigned to the new external subnet. That is, an external subnet (e.g., external subnet 114 of FIG. 1) can be updated, and this can involve performing create new NIC 214 and attach NIC 216 of FIG. 2 for each VM in a cluster (e.g. VM(s) 116 of computer cluster 102).

After operation 404, process flow moves to operation 406.

Operation 406 depicts setting the cluster to a maintenance mode. This can be performed in a similar manner as set cluster into maintenance mode 218 of FIG. 2.

After operation 406, process flow moves to operation 408.

Operation 408 depicts creating the new external subnet. This can be performed in a similar manner as create new groupnet/subnet 222 of FIG. 2.

In some examples, the creating of the new external subnet is based on sending a creation command from an orchestration component to the cluster. That is, orchestration 204 can issue this command.

After operation 408, process flow moves to operation 410.

Operation 410 depicts deleting respective current virtual network interface cards from the respective virtual machines, wherein the respective current virtual network interface cards are assigned to the current external subnet. This can be performed in a similar manner as delete vNIC assigned to old delegated subnet 328 of FIG. 3.

After operation 410, process flow moves to operation 412.

Operation 412 depicts acquiring respective dynamic host control protocol (DHCP) leases for the respective virtual machines, wherein the respective dynamic host control protocol (DHCP) leases correspond to the new external subnet. This can be performed in a similar manner as reacquire DHCP lease 324 of FIG. 3.

After operation 412, process flow moves to operation 414.

Operation 414 depicts halting the maintenance mode for the cluster. This can be performed in a similar manner as stop drain services on nodes 326 and unset maintenance mode 338 of FIG. 3.

After operation 414, process flow moves to operation 416.

Operation 416 depicts accepting a connection from a computer on the new external subnet via the respective new virtual network interface cards. This can be similar to a connection from remote computer 106 of FIG. 1.

After operation 416, process flow moves to 418, where process flow 400 ends.

FIG. 5 illustrates another example process flow 500 that can facilitate orchestration to update an external subnet of a clustered filesystem on a cloud platform, in accordance with an embodiment of this disclosure. In some examples, one or more embodiments of process flow 500 can be implemented by orchestration to update an external subnet of a clustered filesystem on a cloud platform component 108 of FIG. 1, or computing environment 1000 of FIG. 10.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 400 of FIG. 4, process flow 600 of FIG. 6, process flow 700 of FIG. 7, process flow 800 of FIG. 8, and/or process flow 900 of FIG. 9.

Process flow 500 begins with 502, and moves to operation 504.

Operation 504 depicts, for each of the respective virtual machines, sending a creation command from an orchestration component to a cloud platform that comprises the cluster. This can be performed in a similar manner as create new vNIC 214 of FIG. 2, which is sent from orchestration 204 and to cloud provider 206.

After operation 504, process flow 500 moves to operation 506.

Operation 506 depicts the cloud platform sending a command to the respective virtual machine to attach the respective new virtual network interface card of the new virtual network interface cards. This can be performed in a similar manner as attach vNIC 216 of FIG. 2, which is sent from cloud provider 206 and to cluster 208.

After operation 506, process flow 500 moves to 508, where process flow 500 ends.

Process flow 500 can be implemented to facilitate operation 404 of FIG. 4.

FIG. 6 illustrates another example process flow 600 that can facilitate orchestration to update an external subnet of a clustered filesystem on a cloud platform, in accordance with an embodiment of this disclosure. In some examples, one or more embodiments of process flow 600 can be implemented by orchestration to update an external subnet of a clustered filesystem on a cloud platform component 108 of FIG. 1, or computing environment 1000 of FIG. 10.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 400 of FIG. 4, process flow 500 of FIG. 5, process flow 700 of FIG. 7, process flow 800 of FIG. 8, and/or process flow 900 of FIG. 9.

Process flow 600 begins with 602, and moves to operation 604.

Operation 604 depicts, after the creating of the new external subnet sending a command from an orchestration component to the cluster indicative of cloning a configuration between the current external subnet and the new external subnet. This can be similar to cloning a configuration between subnets 224 of FIG. 2, which is sent between orchestration 204 and cluster 208.

After operation 604, process flow 600 moves to operation 606.

Operation 606 depicts cloning a configuration between the current external subnet and the new external subnet. This can be performed by cluster 208 of FIG. 2.

In some examples, the cloning of the configuration comprises cloning a service name field, a description filed, a name field, a domain name system zone field, a domain name system zone alias field, a time to live value field, or an allocation/connect policy between the current external subnet and the new external subnet. In some examples, the cloning of the configuration comprises configuring an interface of the new external subnet based on the current external subnet, or setting a provisioning rule of the new external subnet based on the current external subnet. That is, there can be specific fields to carry over such as: service name, descriptions, names, DNS zone, DNS zone aliases, TTL, allocate/connect policy, configure interfaces, and provisioning rules.

After operation 606, process flow 600 moves to 608, where process flow 600 ends.

FIG. 7 illustrates another example process flow 700 that can facilitate orchestration to update an external subnet of a clustered filesystem on a cloud platform, in accordance with an embodiment of this disclosure. In some examples, one or more embodiments of process flow 700 can be implemented by orchestration to update an external subnet of a clustered filesystem on a cloud platform component 108 of FIG. 1, or computing environment 1000 of FIG. 10.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 400 of FIG. 4, process flow 500 of FIG. 5, process flow 600 of FIG. 6, process flow 800 of FIG. 8, and/or process flow 900 of FIG. 9.

Process flow 700 begins with 702, and moves to operation 704.

Operation 704 depicts cloning the configuration between the current external subnet and the new external subnet. This can be similar to cloning a configuration between subnets 224 of FIG. 2.

After operation 704, process flow 700 moves to operation 706.

Operation 706 depicts setting a virtual Internet Protocol address for the new external subnet based on sending a command from the orchestration component to the cluster, where the virtual Internet Protocol address identifies a cluster-aware domain name system load balancing server. This can be performed in a similar manner as set cluster-aware domain name system load balancing server IP addresses from new subnet 226 of FIG. 2.

In some examples, the setting of the virtual Internet Protocol address comprises assigning the virtual Internet Protocol address to a network address within a range of network addresses of the new external subnet.

That is, a cluster-aware DNS load balancing server can be accessible via a virtual IP. It can be that DNS servers can have a fixed set of IP addresses they resolve to. However, a cluster-aware DNS load balancing server can be integrated with a cluster operating system deeply enough to know the status of all nodes and IP addresses, which can facilitate ensure that IP addresses in DNS responses are up and usable for whatever protocol the client wants to use. A virtual IP address, as used here, can float between nodes to facilitate the cluster-aware DNS load balancing server being available (e.g., at times of a node being inaccessible).

After operation 706, process flow 700 moves to 708, where process flow 700 ends.

FIG. 8 illustrates another example process flow 800 that can facilitate orchestration to update an external subnet of a clustered filesystem on a cloud platform, in accordance with an embodiment of this disclosure. In some examples, one or more embodiments of process flow 800 can be implemented by orchestration to update an external subnet of a clustered filesystem on a cloud platform component 108 of FIG. 1, or computing environment 1000 of FIG. 10.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 400 of FIG. 4, process flow 500 of FIG. 5, process flow 600 of FIG. 6, process flow 700 of FIG. 7, and/or process flow 900 of FIG. 9.

Process flow 800 begins with 802, and moves to operation 804.

Operation 804 depicts creating and attaching respective first virtual network interface cards (vNICs) to respective virtual machines, wherein the respective first virtual network interface cards (vNICs) are assigned to a new external subnet. In some examples, operation 804 can be implemented in a similar manner as operation 404 of FIG. 4.

After operation 804, process flow moves to operation 806.

Operation 806 depicts setting a cluster that comprises the virtual machines to a maintenance mode. In some examples, operation 806 can be implemented in a similar manner as operation 406 of FIG. 4.

In some examples, the setting of the cluster to the maintenance mode results in the cluster refusing new connections. In some examples, the setting of the cluster to the maintenance mode results in the cluster setting respective nodes of the cluster to a drain mode. In some examples, the halting of the maintenance mode for the cluster results in the cluster halting the drain mode for the respective nodes. That is, setting maintenance mode, and subsequently starting a drain service, can prevent new connections being made during a time of modifying an external subset, and so minimize (or reduce) the timeframe between the two cutovers that can be involved in the process.

It can be that a disruption to client traffic is unavoidable in a change of external subnet/re-IP (where a change of external subnet is a form of re-IP). Where a disruption to client traffic happens, the present techniques can be implemented to minimize a number and duration of disruptions.

After operation 806, process flow moves to operation 808.

Operation 808 depicts creating the new external subnet. In some examples, operation 808 can be implemented in a similar manner as operation 408 of FIG. 4.

After operation 808, process flow moves to operation 810.

Operation 810 depicts deleting respective second virtual network interface cards from the respective virtual machines, wherein the respective second virtual network interface cards are assigned to a current external subnet. In some examples, operation 810 can be implemented in a similar manner as operation 410 of FIG. 4.

After operation 810, process flow moves to operation 812.

Operation 812 depicts acquiring respective dynamic host control protocol (DHCP) leases for the respective virtual machines, wherein the respective dynamic host control protocol (DHCP) leases correspond to the new external subnet. In some examples, operation 812 can be implemented in a similar manner as operation 412 of FIG. 4.

After operation 812, process flow moves to operation 814.

Operation 814 depicts halting the maintenance mode for the cluster. In some examples, operation 814 can be implemented in a similar manner as operation 414 of FIG. 4.

In some examples, operation 814 comprises, after the halting of the maintenance mode for the cluster, updating a domain name system delegation record based on the new external subnet, wherein the domain name system delegation record is associated with a virtual Internet Protocol address of the cluster. This can be performed in a similar manner as update DNS delegation records to point to new cluster-aware domain name system load balancing server IPs 342 of FIG. 3. In some examples this can be performed based on receiving user input data from a computer associated with user account 202.

After operation 814, process flow moves to operation 816.

Operation 816 depicts accessing the new external subnet by the cluster via the respective first virtual network interface cards. In some examples, operation 816 can be implemented in a similar manner as operation 416 of FIG. 4.

After operation 816, process flow moves to 818, where process flow 800 ends.

FIG. 9 illustrates another example process flow 900 that can facilitate orchestration to update an external subnet of a clustered filesystem on a cloud platform, in accordance with an embodiment of this disclosure. In some examples, one or more embodiments of process flow 900 can be implemented by orchestration to update an external subnet of a clustered filesystem on a cloud platform component 108 of FIG. 1, or computing environment 1000 of FIG. 10.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 400 of FIG. 4, process flow 500 of FIG. 5, process flow 600 of FIG. 6, process flow 700 of FIG. 7, and/or process flow 800 of FIG. 8.

Process flow 900 begins with 902, and moves to operation 904.

Operation 904 depicts creating and attaching respective first virtual network interface cards to respective virtual machines, wherein the respective first virtual network interface cards are assigned to a first external subnet. In some examples, operation 904 can be implemented in a similar manner as operation 404 of FIG. 4.

In some examples, the first external subnet comprises a first logical subdivision of an Internet Protocol network that addresses devices external to the cluster, and wherein the second external subnet comprises a second logical subdivision of the Internet Protocol network.

After operation 904, process flow 900 moves to operation 906.

Operation 906 depicts setting a cluster that comprises the virtual machines to a maintenance mode. In some examples, operation 906 can be implemented in a similar manner as operation 406 of FIG. 4.

After operation 906, process flow 900 moves to operation 908.

Operation 908 depicts creating the first external subnet. In some examples, operation 908 can be implemented in a similar manner as operation 408 of FIG. 4.

After operation 908, process flow 900 moves to operation 910.

Operation 910 depicts deleting respective second virtual network interface cards from the respective virtual machines, wherein the respective second virtual network interface cards are assigned to a second external subnet. In some examples, operation 910 can be implemented in a similar manner as operation 410 of FIG. 4.

In some examples, the deleting of the respective second virtual network interface cards comprises deleting the current external subnet. That is, a subnet and pool can be deleted from a cluster operating system. From the cloud point of view, this can comprise tearing down the vNICs that were associated with the old subnet.

In some examples, operation 910 comprises, after the deleting of the respective second virtual network interface cards from the respective virtual machines, triggering the respective virtual machines to probe for network devices, where a result of the probing comprises identifying the respective first virtual network interface cards.

In some examples, the result of the probing comprises updating respective network interface configuration files, and the respective first virtual network interface cards are identified in the respective network interface configuration files.

In some examples, prior to the deleting of the respective second virtual network interface cards, the respective second virtual network interface cards are identified in the respective network interface configuration files with respective logical names, and the result of the probing comprises the respective first virtual network interface cards being identified in the respective network interface configuration files with the respective logical names.

In some examples, the respective logical names are respective first logical names, and, prior to the probing, the respective first virtual network interface cards are identified in the respective network interface configuration files with respective second logical names.

That is, there can be a commit to perform the network cutover. As part of the commit, each node can watch for device changes due to the vNIC having been torn down in the cloud. Once the old devices have been removed, a re-probe of the network devices can be triggered, and a result can be reflected in and reflect it in a logical network interface configuration file (e.g., lni.xml). Updating lni. xml after the old device has been removed can effectively do a rename of the new NICs from ext-2 (when they were created) to ext-1 (now that the old NICs have been removed). Once this is complete, a Dynamic Host Control Protocol (DHCP) lease can be re-acquired. This part can be performed automatically based on the old NIC having been removed/deleted.

After operation 910, process flow 900 moves to operation 912.

Operation 912 depicts reacquiring respective dynamic host control protocol leases for the respective virtual machines, wherein the respective dynamic host control protocol leases correspond to the second external subnet. In some examples, operation 912 can be implemented in a similar manner as operation 412 of FIG. 4.

After operation 912, process flow 900 moves to operation 914.

Operation 914 depicts halting the maintenance mode for the cluster. In some examples, operation 914 can be implemented in a similar manner as operation 414 of FIG. 4.

After operation 914, process flow 900 moves to operation 916.

Operation 916 depicts accessing the second external subnet by the cluster via the respective first virtual network interface cards. In some examples, operation 916 can be implemented in a similar manner as operation 416 of FIG. 4.

After operation 916, process flow 900 moves to 918, where process flow 900 ends.

### Example Operating Environment

In order to provide additional context for various embodiments described herein, FIG. 10 and the following discussion are intended to provide a brief, general description of a suitable computing environment 1000 in which the various embodiments of the embodiment described herein can be implemented.

For example, parts of computing environment 1000 can be used to implement one or more embodiments of computer cluster 102, and/or remote computer 106.

In some examples, computing environment 1000 can implement one or more embodiments of the process flows of FIGS. 4-9 to facilitate orchestration to update an external subnet of a clustered filesystem on a cloud platform.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a nonvolatile storage such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are examples, and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
based on determining to update an external subnet from a current external subnet to a new external subnet, for a cluster that comprises a group of nodes and that hosts a group of virtual machines, creating and attaching respective new virtual network interface cards to respective virtual machines of the group of virtual machines, wherein the respective new virtual network interface cards are assigned to the new external subnet;
setting the cluster to a maintenance mode;
creating the new external subnet;
deleting respective current virtual network interface cards from the respective virtual machines, wherein the respective current virtual network interface cards are assigned to the current external subnet;
acquiring respective dynamic host control protocol leases for the respective virtual machines, wherein the respective dynamic host control protocol leases correspond to the new external subnet;
halting the maintenance mode for the cluster; and
accepting a connection from a computer on the new external subnet via the respective new virtual network interface cards.

2. The system of claim 1, wherein the creating and the attaching of the respective new virtual network interface cards to the respective virtual machines comprises:
for each of the respective virtual machines, sending a creation command from an orchestration component to a cloud platform that comprises the cluster, wherein the cloud platform sends a command to the respective virtual machine to attach the respective new virtual network interface card of the new virtual network interface cards.

3. The system of claim 1, wherein the creating of the new external subnet is based on sending a creation command from an orchestration component to the cluster.

4. The system of claim 1, wherein the operations further comprise:
after the creating of the new external subnet, cloning a configuration between the current external subnet and the new external subnet based on sending a command from an orchestration component to the cluster.

5. The system of claim 4, wherein the cloning of the configuration comprises cloning a service name field, a description filed, a name field, a domain name system zone field, a domain name system zone alias field, a time to live value field, or an allocation/connect policy between the current external subnet and the new external subnet.

6. The system of claim 4, wherein the cloning of the configuration comprises configuring an interface of the new external subnet based on the current external subnet, or setting a provisioning rule of the new external subnet based on the current external subnet.

7. The system of claim 4, wherein the command is a first command, and wherein the operations further comprise:
after the cloning of the configuration between the current external subnet and the new external subnet, setting a virtual Internet Protocol address for the new external subnet based on sending a second command from the orchestration component to the cluster, wherein the virtual Internet Protocol address identifies a cluster-aware domain name system load balancing server.

8. The system of claim 7, wherein the setting of the virtual Internet Protocol address comprises assigning the virtual Internet Protocol address to a network address within a range of network addresses of the new external subnet.

9. A method, comprising:
creating and attaching, by a system comprising at least one processor, respective first virtual network interface cards to respective virtual machines, wherein the respective first virtual network interface cards are assigned to a new external subnet;
setting, by the system, a cluster that comprises the virtual machines to a maintenance mode;
creating, by the system, the new external subnet;
deleting, by the system, respective second virtual network interface cards from the respective virtual machines, wherein the respective second virtual network interface cards are assigned to a current external subnet;
acquiring, by the system, respective dynamic host control protocol leases for the respective virtual machines, wherein the respective dynamic host control protocol leases correspond to the new external subnet;
halting, by the system, the maintenance mode for the cluster; and
accessing, by the system, the new external subnet by the cluster via the respective first virtual network interface cards.

10. The method of claim 9, wherein the setting of the cluster to the maintenance mode results in the cluster refusing new connections.

11. The method of claim 9, wherein the setting of the cluster to the maintenance mode results in the cluster setting respective nodes of the cluster to a drain mode.

12. The method of claim 11, wherein the halting of the maintenance mode for the cluster results in the cluster halting the drain mode for the respective nodes.

13. The method of claim 9, wherein the deleting of the respective second virtual network interface cards comprises:
deleting the current external subnet.

14. The method of claim 9, further comprising:
after the halting of the maintenance mode for the cluster, updating, by the system, a domain name system delegation record based on the new external subnet, wherein the domain name system delegation record is associated with a virtual Internet Protocol address of the cluster.

15. A non-transitory computer-readable medium comprising instructions that, in response to execution, cause a system comprising at least one processor to perform operations, comprising:
creating and attaching respective first virtual network interface cards to respective virtual machines, wherein the respective first virtual network interface cards are assigned to a first external subnet;
setting a cluster that comprises the virtual machines to a maintenance mode;
creating the first external subnet;
deleting respective second virtual network interface cards from the respective virtual machines, wherein the respective second virtual network interface cards are assigned to a second external subnet;
reacquiring respective dynamic host control protocol leases for the respective virtual machines, wherein the respective dynamic host control protocol leases correspond to the second external subnet;
halting the maintenance mode for the cluster; and
accessing the second external subnet by the cluster via the respective first virtual network interface cards.

16. The non-transitory computer-readable medium of claim 15, wherein the operations further comprise:
after the deleting of the respective second virtual network interface cards from the respective virtual machines, triggering the respective virtual machines to probe for network devices, wherein a result of the probing comprises identifying the respective first virtual network interface cards.

17. The non-transitory computer-readable medium of claim 16, wherein the result of the probing comprises updating respective network interface configuration files, and wherein the respective first virtual network interface cards are identified in the respective network interface configuration files.

18. The non-transitory computer-readable medium of claim 17, wherein, prior to the deleting of the respective second virtual network interface cards, the respective second virtual network interface cards are identified in the respective network interface configuration files with respective logical names, and wherein the result of the probing comprises the respective first virtual network interface cards being identified in the respective network interface configuration files with the respective logical names.

19. The non-transitory computer-readable medium of claim 18, wherein the respective logical names are respective first logical names, and wherein, prior to the probing, the respective first virtual network interface cards being identified in the respective network interface configuration files with respective second logical names.

20. The non-transitory computer-readable medium of claim 15, wherein the first external subnet comprises a first logical subdivision of an Internet Protocol network that address devices external to the cluster, and wherein the second external subnet comprises a second logical subdivision of the Internet Protocol network.
